(19) United States
(12) Patent Application Publication
(10) Pub. No.: US 2005/0278197 A1
(43) Pub. Date: Dec. 15, 2005

(54) Biometric information reader and system

(76) Inventors: Dana Marie Podczerwinski, Mount Prospect, IL (US); Joseph Podczerwinksi, Mount Prospect, IL (US)

Correspondence Address: LORD, BISSELL & BROOK, 115 SOUTH LASALLE STREET, CHICAGO, IL, 60603, US

(21) Appl. No.: 10/865,657

(22) Filed: Jun. 10, 2004

(51) Int. Cl. G06F 17/60

(52) U.S. Cl. 705/3; 713/186

(57) ABSTRACT

The invention relates to a reader system of biometric information adapted to sense biometric information and process the same.

### TECHNICAL FIELD OF THE INVENTION

The invention relates to a reader system of biometric information adapted to sense biometric information and process the same.

### BACKGROUND OF THE INVENTION

Biometrics refers to the automatic identification of a person based on his/her physiological or behavioral characteristics. This method of identifying a person is preferred over traditional methods involving signatures, picture ID, passwords, and PIN numbers for various reasons: (i) the person to be identified is required to be physically present at the point-of-identification; and (ii) identification based on biometric techniques obviates the need to remember a password or carry a token.

The use of biometric information is finding increasing use in security and information gathering. Biometric information can be used for identification (Who am I?) and for verification (Am I whom I claim to be?). One such application that has not yet utilized biometric information is in the coordination of health information to a patient. The problem can be best illustrated by example.

An unconscious patient is brought to a hospital emergency room for treatment. Unless identification exists on the patient or such information is brought to the treating physician's attention, the patient remains unidentified. Because the patient is unidentified and unconscious, the treating physician cannot know the patient's name, prior medical history, current medical problems, relatives/friends to contact, types of medications the patient uses (if any), health insurance information, etc. The unconscious patient presents myriad problems. The same problems also exist in patients that do not speak the common language of the treating physician, irrespective of whether this patient is conscious. A conscious yet profoundly mentally disabled patient may enter the emergency room and present the same problems. In the conscious patient, information cannot be gleaned unless there is a common language.

Assuming that all goes well with the patient in the emergency room, the same problems exist for the admitted patient. For example, in ward-type rooms, many patients are present and undoubtedly patient charts are mixed up. In busy urban hospitals where hospital beds are in short supply, the patient may spend days in hallways or corridors; again causing problems for coordinating information about the patient with the patient. In any case, it remains paramount for the treating physician and hospital to know the patient information for the right patient.

One further problem is that information needs to be updated periodically. Returning to the examples above, once the treating physician conducts treatment, such information needs to be recorded, keyed to the patient, and retrievable by the next physician. In this regard, a patient is treated in a more informed manner if the patient's information is routinely updated and keyed to the patient. But the problem remains for finding a common language.

There is, however, a common language that exists irrespective of language barriers, consciousness, or mental ability. That is biometric information, which includes any type of information that can be gleaned from a person and keyed to that person. Various types of biometric systems are being used for real-time identification, the most popular are based on face recognition and fingerprint matching. However, there are other biometric systems that utilize iris and retinal scan, speech, facial thermograms, DNA/genome based identifiers, dental, and hand geometry. Once the patient is identified, the patient can be treated so long as the underlying information is readily available.

Finally, with new privacy laws, medical professionals are forbidden from using patient names in public places. To this end, using some biometrics can be a silent identification mode.

### SUMMARY OF THE INVENTION

The foregoing problems are solved and a technical advance is achieved by the present invention. Disclosed is biometric information reader, recorder, processor, and display system, and processes thereof to assist medical personnel in identifying a patient's identity and determining the patient's underlying information. Such information may include the patient's name, social security/insurance number, age, date of birth, insurance information, prior health problems, prior AMA codes, blood type, past medications, current medications, relatives or friend contact information, whether the patient is wanted by law enforcement authorities, allergies, address, current treating physician, etc.

In addition, the system provides for a portable biometric reader to permit mobility of the unit into, for example, patient rooms.

In addition, the system is available in all languages as that is simply a function of software.

### BRIEF DESCRIPTION OF THE DRAWINGS

FIGS. 1 to 9 show various embodiments of the invention.

### DETAILED DESCRIPTION OF THE INVENTION

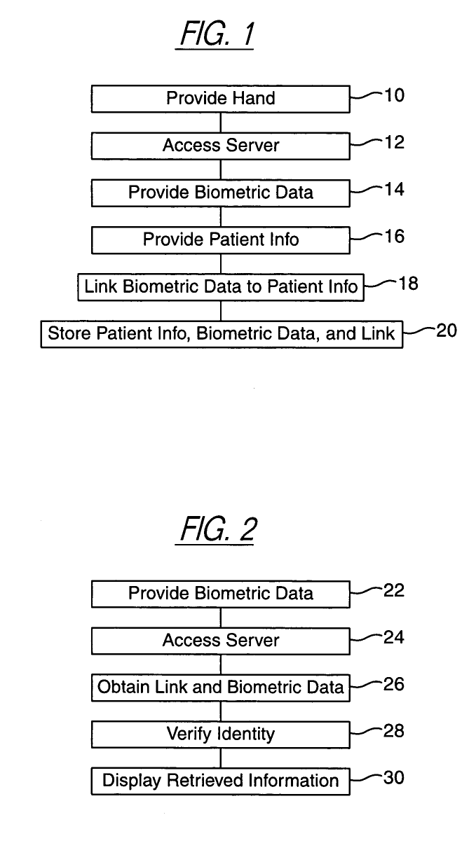

FIG. 1 shows an embodiment of the invention, particularly, the uploading of information into the system. To prepare the system for use or to update the system, the patient's information must be uploaded, stored, and keyed to the biometric identifier. At the outset, it will be noted that biometric information can be collected from the patient such as iris and retinal scan, speech, facial scan, facial thermograms, DNA/genome based identifiers, dental, hand scan, hand geometry, fingerprints, and etc., and any combination thereof. However, for the ease of description, but in no way limiting, the processes and systems will be described as a hand scanner, which may include an in gross scan or a hand geometry scan, palm scan, fingerprint scan, or any combination thereof.

The patient provides 10 the hand for initial scanning to start the process. The system then accesses 12 a server, which becomes ready to accept information entry. The system then scans the hand to generate and upload 14 the biometric data, such as the scan pattern. The patient then provides 16 the patient information, such as, but not limited to, the patient's name, social security/insurance number, age, date of birth, insurance information, prior health problems, prior AMA codes, blood type, past medications, current medications, relatives or friend contact information, whether the patient is wanted by law enforcement authorities, allergies, address, current treating physician, whether the patient is an organ donor, etc. Such information may be manually or electronically updated. The system then links 18 the biometric data to the patient information, and then stores 20 the information, the link, and the patient information. After the first initialization, a set of patient information is now ready to be accessed.

FIG. 2 shows a process chart to access information. The patient provides 22 the biometric data, such as placing the hand on the hand scanner. The scanner reads the hand and generates the scan pattern. The system then accesses 24 the server to begin retrieval of the information. The system then accesses 26 the stored biometric data to see if a preexisting and matching biometric data pattern exists. The system then verifies 28 the identity of the patient and permits continued access if a match is made. If a match is not made, then the system will, in some fashion, indicate that a match failed. The system, optionally, may include a step of creating a patient profile by performing the steps of FIG. 1. In the event a match is made, then the system will permit access to the patient information, and may make available 30 the information, for example, for display, printing, reading, etc.

Various hand scanners may be used. For example, a hand scanner developed by Recognition Systems Inc, of Campbell, Calif. may be adapted for use. Fingerprint devices are commonly available, and include devices from Recognition Systems, Inc., or Identix, Inc. also. To improve scanning efficiency, one might optimize the use of increasing frames per second scanning, automatic finger detection, pressure sensors to monitor how much of a hand is pressed against the scanner, skin color identification, resolution, size of sensing area, number of pixels, scars or other types of dermatological aberrations, or the like.

FIG. 3 shows another embodiment of the invention in which multiple initial scans are completed so that an average profile may be created. This would permit the user to compensate for some poorer quality initial scans, such as involuntary hand movements, dirty hands, inadequate hand pressure, wrinkles, dry skin, or for eyes, involuntary eye movements, blinks, “red eye”, pupil dilation, etc. In short, multiple scans may be necessary to achieve a base line scan that would get stored and to which the later scans be compared. To exemplify one embodiment of the process, the patient may provide 10 a hand, a server accessed 12, and the hand is scanned 14. The first scan data is stored 32 and a loop 30 is completed for a predesignated number of loops. The data scans are then collected and a baseline scan is computed 34, which provides the baseline scan pattern of the biometric data. To this end, multiple hand or eye scans may be completed. Furthermore, multiple scans may be needed when a combination scan pattern is required, for example, if the system requires a hand and fingerprint scan, or a fingerprint and eye scan, or a hand and an eye scan, etc. Recall that each type of biometric data set may be combined to provide for greater assurances of identification or verification.

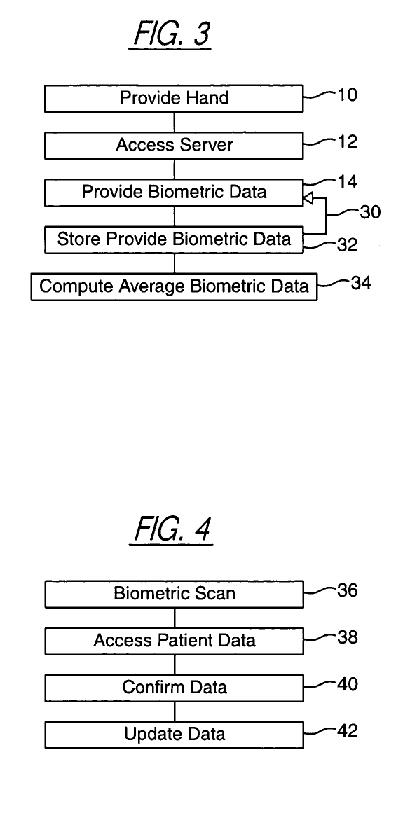

FIG. 4 shows another embodiment of the invention in which a patient checks in with a physician office, a clinic, or the hospital. In this regard, the patient would provide 36 the biometric scan, the patient information would be accessed 38, the patient then could confirm 40 the data to ensure accuracy, and if necessary update 42 the data. In the event the patient is a new patient and has not yet established a profile, the patient could input the data afresh using the scan. One benefit of this system is that patient registration can be streamlined.

FIG. 5 shows another embodiment of the invention in which a patient treatment may occur. As usual, the patient will provide the biometric information 10 and access 12 the patient data. Based on the information retrieved and the new course of treatment, the physician will administer a treatment, which may include taking tests, administering medications, performing a procedure, etc. The physician then can record 44 the treatment given into the system. The system will then update the patient data. Optionally, the system may include a step of comparing 48 the treatment just administered with the prior data to determine if any adverse reactions may occur or to flag certain information for immediate attention. For example, after the physician records 44 the treatment, the system can compare 48 the treatment (for example, medication just given) to the medications in the patient data to determine if an adverse drug reaction may occur. Based on the information flagged, the physician can then administer a countermeasure or take counter-actions. In this regard, patient safety is further benefited. In addition, any information may be inputted or updated via manual entry, electronically, or using voice-input. For example, as the treating physician performs a test or procedure, he can manually enter the procedure or the procedure code, electronically select the procedure from a menu of options, or speak into the unit using voice recognition software. In this regard, the unit can store the voice instruction or the unit can convert the voice into a more readily useable format for updating or billing.

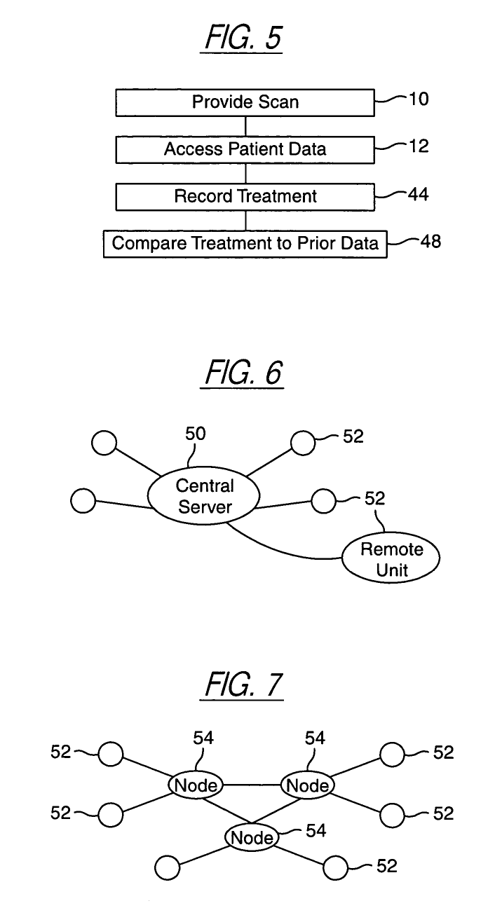

FIG. 6 describes a networked environment of the system. Shown is a central processor 50 and at least one remote unit 52. Central processor 50 may include one or more storage devices, network servers, or the like. One purpose of the central processor is to coordinate the input, processing, storage, retrieval, and output of patient information. As such, as biometric data is inputted and patient information is routed, the central processor 50 will coordinate the inputs and outputs so that the appropriate patient information can be updated, processed, transmitted, or otherwise manipulated.

FIG. 7 shows an expanded network environment having one more nodes 54 connected to one or more remote units. One benefit of having one or more nodes is to optimize performance consistent with the invention described herein. In this regard, many remote users, such as hospitals, ambulance personnel, or physicians may use the system in the manner intended and have optimal performance by having one or more nodes perform some or all of the process steps.

In any embodiment, the biometric input device, such as the eye or hand scanner, or the remote unit 52 may be connected to the system by wire or by wireless. Wireless communication is preferred in certain embodiments where portability is desired. Similarly, any connection between the nodes may be wireless or wired. Similarly, any communication between any two or more units or parts may be wireless or wired.

FIG. 8 shows another embodiment of the invention. While some biometric information input devices may be fixed, e.g., fixed on a countertop, fixed into a wall, doorway, etc., it may be convenient to use a portable unit, such as described above. FIG. 8 shows an embodiment of the portable device. Again using hand scanners as an example of biometric information input devices, a portable device 56 is shown as a tablet. Included on the portable device is a display screen 58, an information input area 60, which may further include input devices such as a keyboard 62, a writing pad 64 and/or a mouse 66. To input information, the user may type on the keyboard 62, or may “write” on the writing pad similar to personal device assistants using stylus stroke recognition software (e.g., Palm® Pilot recognition software), or via a mouse. One or more of these may be included. Also included on the unit 56 is the biometric information input device 68, such as a hand scanner. In this regard, the patient would place the hand on the hand scanner 68, the wired/wireless communication would take place, the retrieved patient information would be displayed on the screen 58. Upon treatment, the physician then can update the patient's information using one or more of the information input devices.

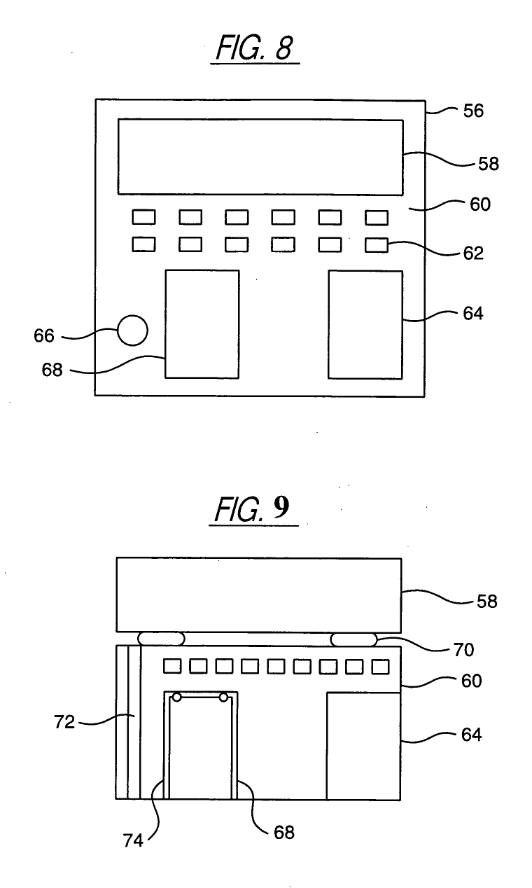

FIG. 9 shows another embodiment of the invention. Whilst the embodiment of FIG. 8 shows a tablet-type device 56, FIG. 9 shows a notebook type device wherein the display area 58 is connected to the information input area 60 by one or more connectors 70, akin to a currently traditional lap-top computer configuration. Further included in this embodiment (and could be included in any embodiment, including the embodiment of FIG. 8) is a card swiper 72. The swiper 72 is capable of reading a magnetic strip on a card, such as a health insurance card. In addition, the swiper may read information off of the card to further provide for identification or verification. Optionally, the information input area 60 may include a protective cover 74 that protects the input area. For example, the cover 74 (as shown in FIG. 9) includes a cover over the hand scanner portion 68. In this regard, the display 58 may be in an open position but yet have the input area 60 protected from spills, blood, inadvertent entries, etc.

Various types of information may be inputted and/or displayed. For example, medical professionals use standard billing codes for procedures, diagnosis, or treatments, such as the Current Procedural Terminology (CPT) codes owned by the American Medical Association; or the Internal Classification of Disease (ICD) codes used for Medicare reimbursements. These codes permit very precise tracking of patient information and may also be used for coordinating patient treatments or for alerting treating personnel of a possible adverse event. The set of codes that may be used can be modified or supplemented as necessary. In this regard, there is another embodiment of the invention in that billing may be facilitated. For example, upon updating the patient information, the information can be transmitted to a billing entity such as a billing service, collections department, or insurance company.

Accordingly, in yet another embodiment of the invention, there is disclosed an increasing billing efficiency because the physician can immediately input the treatment, which the system will then transmit to the billing system to generate the invoices for payment. In this regard, billings are maximized because a nearly real-time record of any procedures, diagnostics, or treatments is created.

From this disclosure, there is also disclosed a method of using biometric information to coordinate patient identity with that patient's health information. Conventional biometric reading units may be used to specifically identify a patient and to access stored patient information. In this regard, the method may also use specially designed units, such as the units described in FIGS. 8 and 9.

It should be understood that the foregoing relates only to a limited number of embodiments that have been provided for illustration purposes only. It is intended that the scope of invention is defined by the appended claims and that modifications to the embodiments above may be made that do not depart from the scope of the claims.

1. A process to ensure health patient identification or identity verification, comprising:
(a) initializing a biometric reader system to accept a patient information profile; and
(b) linking the patient information profile to at least one biometric identifier.

2. The process of claim 1, wherein the step of initializing the biometric reader comprises the step of providing the patient information profile.

3. The process of claim 2, wherein the step of providing the patient profile comprises providing at least one of the patient's name, social security/insurance number, address, age, date of birth, health insurance information, prior health problems, prior treatments, prior diagnoses, current or past medications, emergency contact information, allergies, current or past treating physicians, prior aliases, and current law enforcement authority information.

4. The process of claim 1, wherein the at least one biometric identifier comprises at least one of the patient's iris scan, retinal scan, speech pattern, facial scan, facial thermogram, DNA/genome profile, dental scan, hand scan, hand geometry scan, fingerprint, or any combination thereof.

5. The process of claim 3, wherein the at least one biometric identifier comprises at least one of the patient's iris scan, retinal scan, speech pattern, facial scan, facial thermogram, DNA/genome profile, dental scan, hand scan, hand geometry scan, fingerprint, or any combination thereof.

6. The process of claim 5, further comprising the step of storing the patient information profile, the link of the profile to the biometric identifier, and the at least one biometric identifier.

7. A process to ensure health patient identification or identity verification, comprising:
(a) obtaining a biometric identifier from a biometric scanner; and
(b) retrieving a health patient information profile that correlates to the biometric identifier.

8. The process of claim 7, wherein the step of obtaining the biometric identifier further comprises obtaining at least one identifier from a patient's iris scan, retinal scan, speech pattern, facial scan, DNA/genome profile, dental scan, hand scan, hand geometry scan, fingerprint, or any combination thereof.

9. The process of claim 7, further comprising displaying the patient information profile.

10. The process of claim 7, further comprising updating the information profile.

11. The process of claim 7, further comprising obtaining another biometric identifier from a biometric scanner before retrieving the health patient information profile.

12. The process of claim 7, further comprising networking the biometric scanner and the patient information profile.

13. The process of claim 12, further comprising updating the information profile.

14. The process of claim 13, further comprising displaying the patient information profile.

15. The process of claim 10, further comprising comparing the updated information to the information profile.

16. The process of claim 7, wherein the biometric scanner is a portable biometric scanner.

17. The process of claim 10, further comprising transmitting the updated information to a billing entity.

18. The process of claim 7, further comprising:
displaying the patient information profile;
updating the information profile;
networking the biometric scanner and the patient information profile;
wherein the step of obtaining the biometric identifier further comprises obtaining at least one identifier from a patient's iris scan, retinal scan, speech pattern, facial scan, DNA/genome profile, dental scan, hand scan, hand geometry scan, fingerprint, or any combination thereof; and
wherein the biometric scanner is a portable biometric scanner.

19. An apparatus to ensure patient identification or identity verification, comprising:
(a) a biometric scanner; and
(b) a means to input patient information in response to activation by the biometric scanner.

20. The apparatus of claim 19, wherein the apparatus is portable.
